(19) United States
(12) Patent Application Publication
(10) Pub. No.: US 2025/0133523 A1
(43) Pub. Date: Apr. 24, 2025

(54) METHOD AND DEVICE IN WIRELESS COMMUNICATION SYSTEM

(71) Applicant: Samsung Electronics Co., Ltd., Suwon-si, Gyeonggi-do (KR)

(72) Inventors: He WANG, Beijing (CN); Xutao ZHOU, Beijing (CN); Yankun LI, Beijing (CN); Yunchuan YANG, Beijing (CN); Chanho AN, Suwon-si (KR)

(21) Appl. No.: 18/836,585

(22) PCT Filed: Feb. 1, 2023
(86) PCT No.: PCT/KR2023/001466

§ 371 Date: Aug. 7, 2024

(30) Foreign Application Priority Data
Feb. 11, 2022 (CN) 202210130409.X

(51) Int. Cl. H04W 56/00

(52) U.S. Cl. CPC H04W 56/0045; H04W 56/001

(57) ABSTRACT

The present disclosure discloses a method and device in a wireless communication system. A method performed by a user equipment (UE) in a wireless communication system, comprising: receiving, by the UE, uplink timing advance (TA) related information from a network-side entity; determining uplink timing advance (TA), by the UE, based on the received uplink timing advance (TA) related information, and downlink timing related information, wherein the downlink timing related information comprises a current downlink timing T₁ of the UE and a downlink timing T₂ obtained by the UE based on a received specific downlink reference signal; and transmitting an uplink signal to the network-side entity based on the determined TA.

### TECHNICAL FIELD

The present disclosure relates to the technical field of wireless communication, and more particularly, to a method and device in a wireless communication system, including a user equipment and network-side equipment.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedure (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

According to an aspect of the present disclosure, provided herein is a method performed by a user equipment (UE) in a wireless communication system, the method comprising: receiving, by the UE, uplink timing advance (TA) related information from a network-side entity; determining uplink timing advance (TA), by the UE, based on the received uplink timing advance (TA) related information and downlink timing related information, wherein the downlink timing related information comprises a current downlink timing T₁ of the UE and a downlink timing T₂ obtained by the UE based on a received specific downlink reference signal; and transmitting an uplink signal to the network-side entity based on the determined TA.

In a further embodiment, the specific downlink reference signal comprises: a synchronization signal block (SSB) and/or channel state information reference signal (CSI-RS) and/or tracking reference signal (TRS), wherein the specific downlink reference signal corresponds to a target transmission configuration indicator (TCI) state received by the UE.

In a further embodiment, an absolute value of a downlink timing difference between the downlink timing T₂ and the downlink timing T₁ is greater than a certain threshold.

In a further embodiment, the target TCI state and a current TCI state of the UE are in different TCI state groups; or a SSB corresponding to the target TCI state and a SSB corresponding to the current TCI state of the UE are in different SSB groups; or a SSB-related RRH corresponding to the target TCI state is different from a SSB-related RRH corresponding to the current TCI state of the UE.

In a further embodiment, TCI state group information or SSB group information or SSB-related RRH information or cross-RRH or inter-RRH switching is determined by the UE from first information or third information received from the network-side entity, wherein the third information is determined by the network-side entity based on second information it receives from the UE.

In a further embodiment, the TA is determined by: TA=T₂−(N_{TA}+N_{TA offset})*T_{c}+C*(T₁−T₂), wherein C and T_{c} are constants, N_{TA offset} is a timing advance offset, N_{TA} is a value determined based on a timing advance command, and wherein, N_{TA offset} and N_{TA} are determined based on the received uplink timing advance (TA) related information.

In a further embodiment, the method further comprises: performing, by the UE, an uplink timing adjustment, such that a TA value used by the UE gradually approaches (N_{TA}+N_{TA offset})*T_{c}, wherein N_{TA offset} and N_{TA} are determined based on the received uplink timing advance (TA) related information, and wherein T_{c} is a constant.

In a further embodiment, the first information comprises at least one of: information on a relationship between SSBs and/or correspondence between SSBs and RRHs, wherein the first information is indicated via cell broadcast information or via UE configuration information; and a relationship between TCI states and/or correspondence between TCI states and RRHs, wherein the first information is indicated via the UE configuration information.

In a further embodiment, the first information is used to indicate whether a UE enables or disables one shot uplink timing adjustment or whether the UE is allowed to enable or disable one shot uplink timing adjustment, which comprises at least one of: information transmitted through cell broadcast information, which is used to indicate whether all the UEs in the cell enable or disable one shot uplink timing adjustment or whether the UEs are allowed to enable or disable one shot uplink timing adjustment; information transmitted through cell broadcast information, which is used to indicate whether a specific UE in a cell enables or disables one shot uplink timing adjustment or whether the specific UE in the cell is allowed to enable or disable one shot uplink timing adjustment; and information transmitted in configuration information for the UE, which is used to indicated that the UE enables or disables one shot uplink timing adjustment or whether the UE is allowed to enable or disable one shot uplink timing adjustment.

In a further embodiment, the specific UE comprises at least one of: a UE with a specific transmission power class; a UE with a specific user equipment type; and a UE supporting uplink timing adjustment.

In a further embodiment, the second information comprises at least one of: user equipment capabilities; and user equipment operating states.

In a further embodiment, the user equipment capabilities comprise at least one of: a radio frequency power class of a user equipment; a UE type corresponding to the transmission power class of the user equipment; capabilities in a high-speed railway scenario corresponding to the UE type corresponding to the transmission power class of the user equipment; and a capability as to whether the user equipment supports uplink timing adjustment.

In a further embodiment, the operating states comprise at least one of: a radio frequency operating mode of the UE; a mobility management operating mode of the UE; and a high-speed mobility state of the UE.

In a further embodiment, the third information comprises at least one of: a MAC CE for indicating TCI state related information, the MAC CE indicating a TCI state corresponding to a UE-specific PDCCH and whether a beam corresponding to the TCI state and a beam corresponding to a TCI state of a currently used PDCCH meet a first specific condition; information in configuration information for the UE indicating a relationship between SSBs, and/or correspondence between SSBs and RRHs; information in configuration information for the UE indicating a relationship between TCI states and/or correspondence between TCI states and RRHs; and a MAC CE indicating a TCI state corresponding to a UE-specific PDCCH and UE timing advance command.

In a further embodiment, the third information is used for indicating that the UE enables or disables one shot uplink timing adjustment or whether the UE is allowed to enable or disable one shot uplink timing adjustment, which comprises: information transmitted in configuration information for the UE, which is used to indicate whether the UE enables or disables one shot uplink timing adjustment or whether the UE is allowed to enable or disable one shot uplink timing adjustment.

In a further embodiment, the first specific condition is at least one of: a propagation delay difference of all beams arriving at the UE being less than a preset value; all beams being from a same transmission-reception point TRP; all beams being from different TRPs with a distance between the TRPs being less than a preset value; all beams being from a same RRH antenna panel; all beams being from different antenna panels at a same RRH site, wherein the different antenna panels must point towards a same direction; and all beams being from different antenna panels at a same RRH site, wherein the different antenna panels may point towards different directions.

According to another aspect of the present disclosure, provided herein is a user equipment (UE) in a wireless communication system, the UE comprising: a transceiver configured to transmit and receive a signal; and a processor configured to control the transceiver to perform the methods of various embodiments described above.

According to another aspect of the present disclosure, provided herein is a method performed by a network-side entity in a wireless communication system, the method comprising: transmitting, by the network-side entity, uplink timing advance (TA) related information to a user equipment (UE); receiving, by the network-side entity, an uplink signal from the UE, wherein the uplink signal is transmitted based on a TA determined by the UE based on the transmitted uplink timing advance (TA) related information and downlink timing related information, wherein the downlink timing related information comprises a current downlink timing T₁ of the UE and a downlink timing T₂ obtained by the UE based on a received specific downlink reference signal.

In a further embodiment, the specific downlink reference signal comprises: a SSB and/or CSI-RS and/or TRS, wherein the specific downlink reference signal corresponds to a target TCI state received by the UE.

In a further embodiment, an absolute value of a downlink timing difference between the downlink timing T₂ and the downlink timing T₁ is greater than a certain threshold.

In a further embodiment, the target TCI state and a current TCI state of the UE are in different TCI state groups; or a SSB corresponding to the target TCI state and a SSB corresponding to the current TCI state of the UE are in different SSB groups; or a SSB-related remote radio head (RRH) corresponding to the target TCI state is different from a SSB-related RRH corresponding to the current TCI state of the UE.

In a further embodiment, TCI state group information or SSB group information or SSB-related RRH information or cross-RRH or inter-RRH switching is determined by the UE from first information or third information received from the network-side entity, wherein the third information is determined by the network-side entity based on second information it receives from the UE.

In a further embodiment, the TA is determined by: TA=T₂−(N_{TA}+N_{TA offset})*T_{c}+C*(T₁−T₂), wherein C and T_{c} are constants, N_{TA offset} is a timing advance offset, and N_{TA} is a value determined based on a timing advance command, and wherein, N_{TA offset} and N_{TA} are determined based on the transmitted uplink timing advance (TA) related information.

In a further embodiment, the first information comprises at least one of: information on a relationship between SSBs and/or correspondence between SSBs and RRHs, wherein the first information is indicated via cell broadcast information or via UE configuration information; and a relationship between TCI states and/or correspondence between TCI states and RRHs, wherein the first information is indicated via the UE configuration information.

In a further embodiment, the first information is used to indicate whether a UE enables or disables one shot uplink timing adjustment or whether the UE is allowed to enable or disable one shot uplink timing adjustment, which comprises at least one of: information transmitted through cell broadcast information, which is used to indicate whether all the UEs in the cell enable or disable one shot uplink timing adjustment or whether the UEs are allowed to enable or disable one shot uplink timing adjustment; information transmitted through cell broadcast information, which is used to indicate whether a specific UE in a cell enables or disables one shot uplink timing adjustment or whether the specific UE in the cell is allowed to enable or disable one shot uplink timing adjustment; and information transmitted in configuration information for the UE, which is used to indicated that the UE enables or disables one shot uplink timing adjustment or whether the UE is allowed to enable or disable one shot uplink timing adjustment.

In a further embodiment, the specific UE comprises at least one of: a UE with a specific transmission power class; a UE with a specific user equipment type; and a UE supporting uplink timing adjustment.

In a further embodiment, the second information comprises at least one of: user equipment capabilities; and user equipment operating states.

In a further embodiment, the user equipment capabilities comprise at least one of: a transmission power class of a user equipment; a UE type corresponding to the transmission power class of the user equipment; capabilities in a high-speed railway scenario corresponding to the UE type corresponding to the transmission power class of the user equipment; and a capability as to whether the user equipment supports uplink timing adjustment.

In a further embodiment, the operating states comprise at least one of: a radio frequency operating mode of the UE; a mobility management operating mode of the UE; and a high-speed mobility state of the UE.

In a further embodiment, the third information comprises at least one of: a MAC CE for indicating TCI state related information, the MAC CE indicating a TCI state corresponding to a UE-specific PDCCH and whether a beam corresponding to the TCI state and a beam corresponding to a TCI state of a currently used PDCCH meet a first specific condition; information in configuration information for the UE indicating a relationship between SSBs, and/or correspondence between SSBs and RRHs; information in configuration information for the UE indicating a relationship between TCI states and/or correspondence between TCI states and RRHs; and a MAC CE indicating a TCI state corresponding to a UE-specific PDCCH and UE timing advance command.

In a further embodiment, the third information is used for indicating that the UE enables or disables one shot uplink timing adjustment or whether the UE is allowed to enable or disable one shot uplink timing adjustment, which comprises: information transmitted in configuration information for the UE, which is used to indicate whether the UE enables or disables one shot uplink timing adjustment or whether the UE is allowed to enable or disable one shot uplink timing adjustment.

In a further embodiment, the first specific condition is at least one of: a propagation delay difference of all beams arriving at the UE being less than a preset value; all beams being from a same transmission-reception point TRP; all beams being from different TRPs with a distance between the TRPs being less than a preset value; all beams being from a same RRH antenna panel; all beams being from different antenna panels at a same RRH site, wherein the different antenna panels must point towards a same direction; and all beams being from different antenna panels at a same RRH site, wherein the different antenna panels may point towards different directions.

According to yet another aspect of the present disclosure, provided herein is a network-side entity in a wireless communication system, which comprises: a transceiver configured to transmit and receive a signal; and a processor configured to control the transceiver to perform the methods of various embodiments described above.

### BRIEF DESCRIPTION OF DRAWINGS

FIG. 1 is an overall structure of a wireless network;

FIG. 2a and FIG. 2b illustrate transmission path and reception path;

FIG. 3a and FIG. 3b are structure diagrams of a UE and a base station, respectively;

FIG. 4 illustrates a schematic diagram in which several remote radio heads are controlled by a baseband control unit of a base station;

FIG. 5 illustrates a schematic diagram in which wireless network service are provided only by antenna panels located on a same side of an RRH site;

FIG. 6 illustrates a schematic diagram in which wireless network service may be provided by antenna panels located on different sides of an RRH site;

FIG. 7 illustrates a schematic diagram of a random access-based scheme; and

FIG. 8 illustrates a method performed by a UE according to an embodiment of the present disclosure.

### MODE FOR THE INVENTION

In order to make the objectives, solutions and advantages of the embodiments of the present disclosure clearer, the solutions of the embodiments of the present disclosure will be clearly and completely described below with reference to the accompanying drawings of the embodiments of the present disclosure. Obviously, the described embodiments are some, but not all, of the embodiments of the present disclosure. Based on the described embodiments of the present disclosure, all other embodiments obtained by persons skilled in the art without creative efforts shall fall within the scope of the present disclosure.

Before undertaking the detailed description below, it may be advantageous to set forth definitions of certain words and phrases used throughout this patent document. The term “couple” and its derivatives mean any direct or indirect communication between two or more elements, whether or not those elements are in physical contact with each other. The terms “transmit”, “receive” and “communicate” and their derivatives encompass both direct and indirect communications. The terms “include” and “comprise,” as well as derivatives thereof, mean inclusion without limitation. The term “or,” is inclusive, meaning and/or. The phrase “associated with” and derivatives thereof, mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system or part thereof that controls at least one operation. Such a device may be implemented in hardware, firmware or software, or some combination of at least two of the same. The functionality associated with any particular controller may be centralized or distributed, whether locally or remotely. The phrase “at least one of” when used with a list of items means that different combinations of one or more of the listed items may be used, and that only one item of the list may be required. For example, “at least one of A, B, and C” comprises any of the following combinations: A, B, C, A and B, A and C, B and C, and A and B and C. For example, “at least one of A, B, or C” comprises any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The terminology used herein to describe embodiments of the disclosure is not intended to limit and/or define the scope of the disclosure. For example, unless otherwise defined, technical or scientific terms used in this disclosure should be given the ordinary meaning as understood by one of ordinary skill in the art to which this disclosure belongs.

It should be understood that use of “first,” “second,” and similar terms in this disclosure do not denote any order, quantity, or importance, but are merely used to distinguish the various components. Unless the context clearly dictates otherwise, the singular forms “a,” “an,” or “the” and similar words do not denote a limitation of quantity, but rather denote the presence of at least one.

As used herein, any reference to “one example” or “example”, “one embodiment” or “an embodiment” means that a particular element, feature, structure or characteristic described in connection with the embodiment is included in at least one in the examples. The appearances of the phrases “in one embodiment” or “in one example” in various places in the specification are not necessarily all referring to the same embodiment.

As used herein, “part” of something means “at least some” of that thing, and thus may mean less than all or all of that thing. Thus, “part” of a thing comprises the whole thing as a special case, i.e., instances where the whole thing is a part of the thing.

As used herein, the term “a set” means one or more. Thus, a set of items may be a single item or a set of two or more items.

In the present disclosure, in order to determine whether a certain condition is met expressions such as “greater than” or “less than” are used as examples, and expressions such as “greater than or equal to” or “less than or equal to” are also applicable, and are not excluded. For example, a condition defined with “greater than or equal to” may be replaced with “greater than” (or vice versa), and a condition defined with “less than or equal to” may be replaced with “less than” (or vice versa), and so on.

It will be further understood that the terms “comprise” or “include” and similar words mean that the elements or things appearing before the word encompass the elements or things listed after the word and their equivalents, but do not exclude other elements or things. Words like “connected to” or “connected with” are not limited to physical or mechanical connections, but may comprise electrical connections, whether direct or indirect. “Up”, “Down”, “Left”, “Right”, etc. are only used to represent the relative positional relationship, and when the absolute position of the described object changes, the relative positional relationship may also change accordingly.

The various embodiments discussed below to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. For example, although the following detailed description of embodiments of the present disclosure will be directed to LTE and 5G communication systems, those skilled in the art will appreciate that the main points of the present disclosure may be modified slightly without substantially departing from the scope of the present disclosure. It can be applied to other communication systems with similar technical background and channel format. The solutions of the embodiments of the present disclosure may be applied to various communication systems. For example, the communication systems may comprise a Global System for Mobile communications (GSM) system, a code division multiple access (CDMA) system, a broadband Code Division Multiple Access (WCDMA) system, General Packet Radio Service (GPRS), Long Term Evolution (LTE) system, LTE Frequency Division Duplex (FDD) system, LTE Time Division Duplex (TDD), universal mobile telecommunication system (UMTS), worldwide interoperability for microwave access (WiMAX) communication system, fifth generation (5th generation, 5G) system or new radio (NR), etc. In addition, the solutions of the embodiments of the present disclosure may be applied to future-oriented communication technologies. In addition, the solutions of the embodiments of the present disclosure may be applied to future-oriented communication technologies.

Hereinafter, embodiments of the present disclosure will be described in detail with reference to the accompanying drawings. It should be noted that the same reference numerals will be used in different drawings to refer to the same elements that have been described.

In order to meet the increasing demand for wireless data communication service since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are devised to be implemented in higher frequency bands, e.g., 28 GHz millimeter wave (mmWave) bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

Aiming at the communication problem in the wireless cellular communication scenario, the present disclosure proposes a scheme to improve the communication performance in this scenario through the interaction information between the network-side entity and the user equipment.

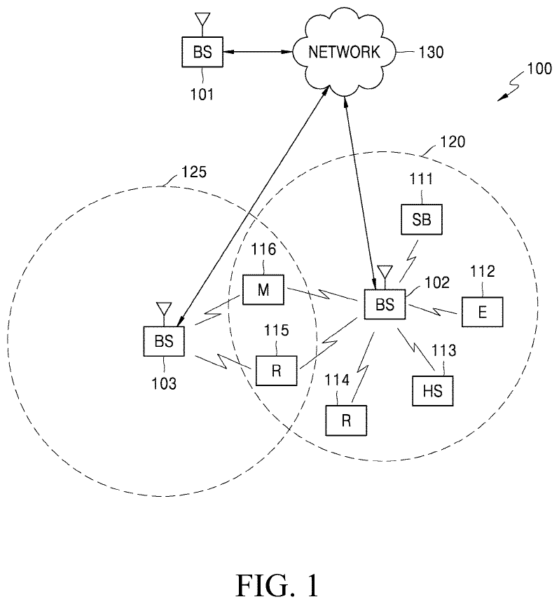

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

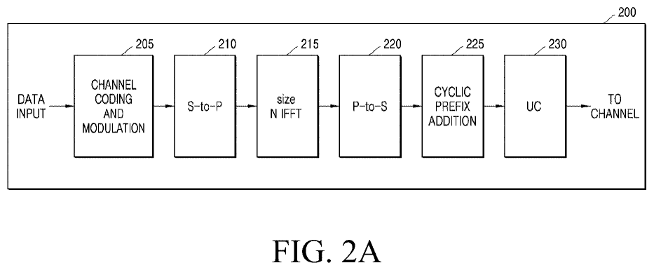

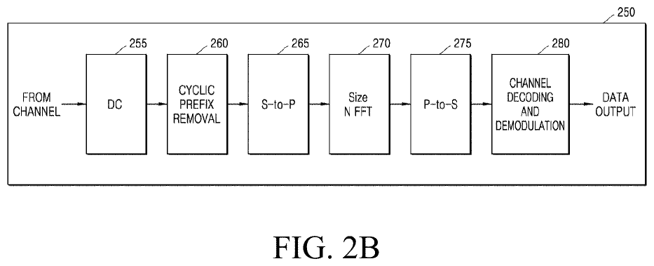

FIGS. 2a and 2b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The upconverter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

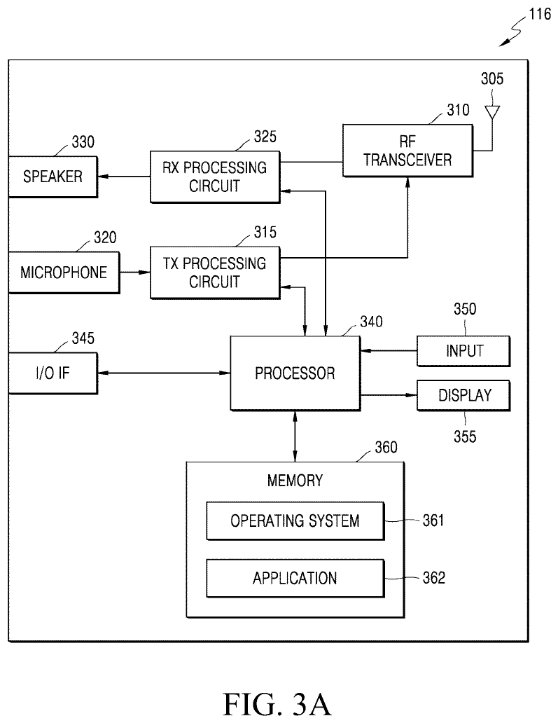

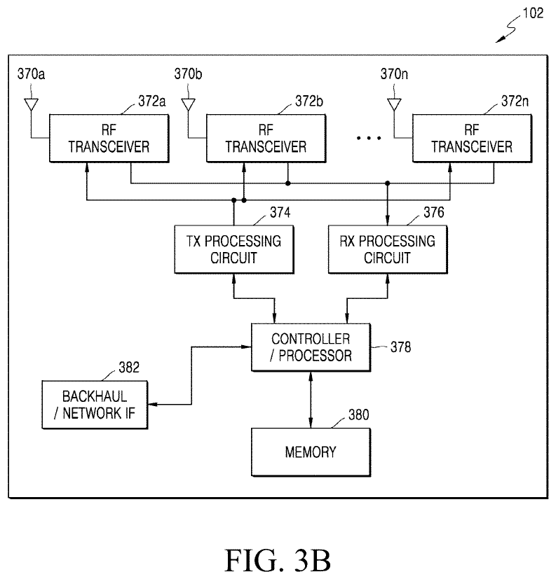

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 may include multiple instances of each (such as one for each RF transceiver).

At the beginning of the research and design of the 5G communication system, one goal was to support high mobility scenarios up to 500 km/h under the premise of ensuring service quality. This goal has been gradually perfected in 4G and 5G communication systems in the frequency range below 6 GHZ, and has also been widely used in practical deployment. In contrast, although wireless communication based on millimeter-wave frequency bands is regarded as a technology capable of supporting ultra-high data rates, the application of millimeter-wave spectrum resources in high-speed mobile communications has not been widely deployed due to technical adjustments and spectrum resource release. Recently, with the expansion of the deployment of 5G communication systems, more and more millimeter-wave systems have begun to be practically applied, and the need to introduce millimeter-wave systems into high-speed mobile scenarios has become more urgent. However, in view of the limitations of millimeter wave propagation loss and the superposition challenges in high-speed mobile situations, compared with 5G communication systems in the frequency range below 6 GHz, there are many technical problems that need to be developed and solved in order to support the application requirements of broadband high-speed mobile communication in the millimeter wave bands. In the 3GPP specification, a mmWave band is often referred to as Frequency Range 2.

High mobility scenarios include but are not limited to: High-Speed Railway Scenario, expressway scenarios, etc. The high-speed railway scenarios comprise: (1) communication between a Handheld User Equipment (UE) and network-side entities; and (2) communication between a User Equipment (UE) located on the roof of the high-speed railway train (Train Roof-Mounted UE) and the network-side entities, wherein the user equipment located on the roof of the high-speed railway train is also called user terminal equipment (Customer Premise Equipment).

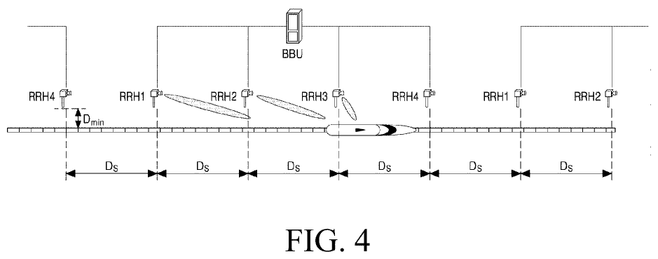

In high mobility scenarios, network-side entities are usually deployed on one or both sides of the trajectory along the movement trajectory of the user equipment: for example, in the High-Speed Railway Scenario, network-side entities are usually deployed along the high-speed railway, on one or both sides of the railway. In addition, for the deployment of network-side entities, the regular scheme is that the baseband unit (BBU in FIG. 1) of a base station (also named as gNodeB, gNB for short in the 5G NR system) controls several remote radio head (RRH in FIG. 4), in which within the coverage of a base station, several RRHs sequentially or simultaneously provide cellular wireless network service for a high-speed user equipment.

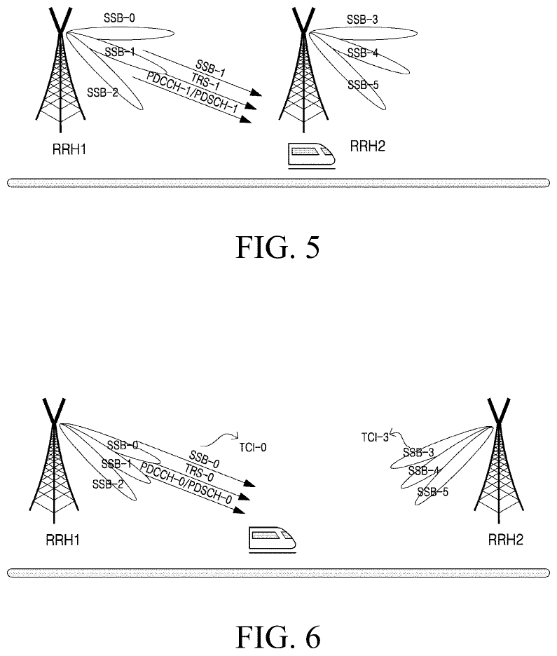

For high-speed railway scenarios, according to the types of RRH deployment on the network-side, it can be generally divided into: uni-directional RRH deployment and bi-directional RRH deployment:
Uni-directional RRH deployment: in uni-directional RRH deployment, for one UE, only the antenna panels located on the same side of different RRH sites provide wireless network service, as illustrated in FIG. 5;
Bi-directional RRH deployment: in bi-directional RRH deployment, for one UE, wireless network service can be provided by antenna panels located on different sides of different RRH sites, as illustrated in FIG. 6.

In the high-speed railway scenario in the frequency range below 6 GHz, under unidirectional RRH or bidirectional RRH deployment, the propagation delay differences between signals transmitted by adjacent RRHs from the same direction are generally much smaller than the time lengths corresponding to the cyclic prefix of the Orthogonal Frequency Division Multiplexing (OFDM) symbols. On the UE receiver side, a single-FFT receiver or a High-Speed Train-Single Frequency Network (HST-SFN) receiver specific for high-speed rail scenarios may be used to receive signals transmitted by adjacent RRHs from the same direction which are superimposed on each other, such that multiple RRHs from the same direction can simultaneously provide service to the UE. However, unlike the above-mentioned high-speed railway scenarios in the frequency range below 6 GHz, in high-speed railway scenarios in the millimeter-wave bands, the propagation delay differences between signals transmitted by adjacent RRHs from the same direction cannot be guaranteed to be much smaller than the cyclic prefix lengths of the OFDM symbols, and in some cases the propagation delay differences can even be greater than the cyclic prefix lengths of the OFDM symbols, and a simple receiver structure cannot be used on the UE receiver side to receive the signals transmitted from adjacent RRHs in the same direction which are superimposed on each other. Therefore, the network needs to use approach of Dynamic Point Selection (DPS), such that adjacent RRHs are switched sequentially to provide signals for the UE.

In the case where a base station uses millimeter wave beamforming to provide a signal to a UE, as the UE moves, it is required to switch and use beams from different directions for the UE. Since the specification of the beam in the 5G NR system is included in the concept of the TCI (Transmission Configuration Indicator) state, this process of switching and use beams from different directions for the UE is called Active TCI state Switching in the specification of the 5G NR system. Since a network generally adopts the DPS mode, the Active TCI state Switching may be divided into inter-RRH, or cross-RRH Active TCI state Switching and intra-RRH Active TCI state Switching.

In unidirectional RRH deployment or bidirectional RRH deployment, when a network-side entity requires a UE to complete inter-RRH, or cross-RRH Active TCI state Switching, a propagation delay difference between a beam corresponding to a source TCI state (or old TCI state) and a beam corresponding to a target TCI state cannot be much smaller than, or possibly even larger than a cyclic prefix length of an OFDM symbol: for example, it is assumed that the distance between adjacent RRHs is 700 meters, in the case of unidirectional RRH deployment, the propagation delay difference of signals from two adjacent RRHs may reach 2.5 microseconds in interRRH, or cross-RRH Active TCI state Switching, which is much larger than the time length corresponding to the cyclic prefix of an OFDM symbol under the 120 kHz SubCarrier Spacing (SCS). Therefore, in inter-RRH, or cross-RRH Active TCI state Switching, there is a propagation delay difference between the signals of the beam corresponding to the source TCI state and the beam corresponding to the target TCI state, which requires the UE and the network to adopt a special scheme for optimization during the inter-RRH, or cross-RRH Active TCI state Switching, which is not required in low-speed scenarios.

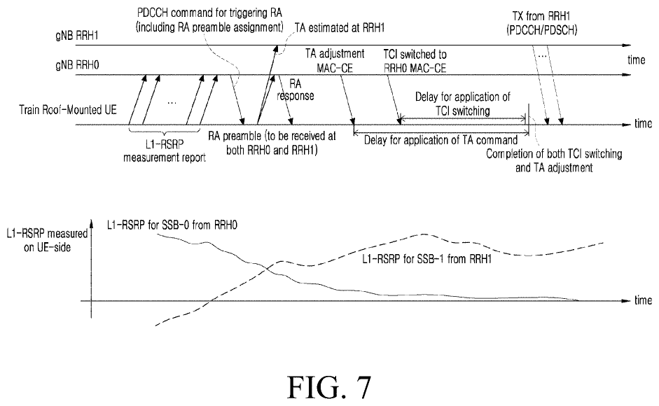

Aiming at the above problem, the existing scheme is a random access-based scheme, as shown in FIG. 7. In this scheme, the network-side needs to configure measuring and reporting Layer-1 Reference Signal Receiving Power (L1-RSRP). During this process, the UE obtains Downlink Timing information of the target TCI state. Based on the L1-RSRP measurement result reported by the UE, the network-side entity determines whether the UE shall perform Active TCI state Switching, and at the same time, the network-side entity needs to timely trigger the random access procedure of the UE and obtain the uplink timing information of the UE.

The following is the timing process of this scheme:
Assuming that the UE moves from the area covered by the source RRH-0 to the area covered by the RRH1, inter-RRH, or cross-RRH Active TCI state Switching needs to be performed. The source active TCI state located in the area covered by RRH-0 corresponds to the Synchronization Signal block with an index of 0 (SSB-0), the target active TCI state located in the area covered by RRH-1 corresponds to the SSB with an index of 1 (SSB-1), and RRH-0 and RRH-1 are connected as two remote radio heads (RRH) to the baseband control unit (BBU) of the same base station.

(1) The base station configures the UE to measure and report L1-RSRP on SSB-0 and SSB-1;

(2) UE performs measurement and triggers L1-RSRP measurement report under appropriate conditions;

(3) Based on the information of L1-RSRP measurement report of the UE, the base station transmits a PDCCH order at a proper time point to trigger the UE to perform random access. The PDCCH order still needs to be transmitted through the source RRH-0, and needs to include the RA preamble sequence and other configuration information;

(4) The UE transmits the RA preamble according to the configuration information in the PDCCH order, and the random access signal needs to be received by the corresponding beams of RRH-0 and RRH-1 at the same time;

(5) The base station estimates uplink (UL) timing advance (TA) amount of the UE on RRH-0 and RRH-1 through the RA preamble received on the respective beams of RRH-0 and RRH-1.

(6) The base station transmits an RA response. The RA response still needs to be transmitted through the source RRH-0.

(7) The base station needs to transmit two MAC CEs (Medium Access Control Elements) simultaneously or successively at an appropriate moment, and these two MAC CEs still need to be transmitted through the source RRH-0:
a. TA command MAC CE: using Timing Advance Command MAC CE or using Absolute Timing Advance Command MAC CE
b. MAC CE related to TCI state switching: such as TCI state Indication for UE-specific PDCCH MAC CE

(8) After receiving the above MAC CEs, the UE applies the target TCI state and the new uplink timing advance amount at an appropriate time point.

(9) After inter-RRH, or cross-RRH Active TCI state Switching is completed, the PDSCH and PDCCH transmissions by the UE use the beams corresponding to the target TCI state.

The problems of the above-mentioned existing RA-based scheme include, but are not limited to that, the scheme requires the network and the UE to apply a timing acquisition process which is complex and tends to fail, during which a waste of resources is caused. In selecting the timing to trigger RA, the UEs and the network-side entities tend to fail to transmit data and control channels normally due to wrongly selected triggering timing occasions.

The present disclosure provides at least a scheme to solve the above-mentioned problems, and the schemes can at least provide the following effects: 1. the network-side entities are enabled to receive the uplink signal transmissions of UEs without updating the UE TA value; and 2. system performance is enhanced in a targeted manner for network-side behavior changes and terminal behavior restrictions under different high-speed states and of the network deployment scenarios.

According to an aspect of the present disclosure, the UE performs corresponding operations based on the received first information and/or third information.

In such a case, the first information is transmitted by a network-side entity to a user equipment (UE). The third information is transmitted by the network-side entity to the UE based on the second information. Specifically, the network-side entity triggers the user equipment to report the second information on the UE capabilities, or the network-side receives the UE self-reported second information on the UE capabilities from the UE and the second information on the UE capabilities is used by the network-side entity to adjust (or optimize) related network configuration in the network-side entity, and/or perform specific configuration for the user equipment.

The present disclosure provides a method for exchanging system information, as well as a user equipment and a network-side entity (herein, a network-side entity is used interchangeably with “a network-side equipment”, which may be, for example, a base station or a relay device), which involves enhancing system performance in a targeted manner for network-side behavior changes and terminal behavior restrictions under different high-speed states and of the network deployment scenarios.

According to another aspect of the present disclosure, the present disclosure discloses schemes for a network-side entity to transmit first information to a user equipment (UE) such that the UE obtains corresponding information. Specifically, based on the first information transmitted by the network-side entity to the user equipment (UE), the UE can determine the characteristics of the Active TCI state Switching configured by the network-side entity, such as whether it is inter-RRH switching, such that the UE can perform corresponding optimization and operations. The first information comprises at least one of the following:
Scheme 1: information indicating a relationship between SSBs (Synchronization Signal blocks) and/or correspondence between SSBs and RRHs in broadcast or multicast information (e.g., information contained in a broadcast System Information Block (SIB)):
The relationship between SSBs: for example, one or more SSB indexes being grouped into one SSB group, all SSB indexes being grouped into multiple SSB groups, beams corresponding to SSB indexes in a same group meeting a condition X, and beams corresponding to SSB indexes in different groups not meeting the condition X;
The correspondence between SSBs and RRHs: for example, RRH index (or indexes) corresponding to one or more SSB indexes, so as to determine SSB index information corresponding to each RRH.
Scheme 2: indicating information on a relationship between Synchronization Signal Blocks (SSBs) and/or correspondence between SSBs and RRHs in configuration information for the user equipment (e.g., RRC signaling for the user equipment):
The relationship between SSBs: for example, one or more SSB indexes being grouped into one SSB group, all SSB indexes being grouped into multiple SSB groups, beams corresponding to SSB indexes in a same group meeting a condition X, and beams corresponding to SSB indexes in different groups not meeting the condition X;
The correspondence between SSB and RRH: for example, RRH number(s) corresponding to one or more SSB indexes, so as to determine SSB index information corresponding to each RRH.
Scheme 3: information indicating a relationship between TCI states and/or correspondence between TCI states and RRHs in configuration information for the user equipment (e.g., RRC signaling for the user equipment):
The relationship between TCI states: for example, one or more TCI states being grouped into one TCI state group, all TCI states being grouped into multiple TCI state groups, beams corresponding to TCI states in a same group meeting condition X, and beams corresponding to TCI states in different groups not meeting the condition X;
The correspondence between TCI states and RRHs: for example, RRH number(s) corresponding to one or more TCI states, so as to determine TCI state information corresponding to each RRH.

The above condition X comprises at least one of the following:
Scheme 1: propagation delay differences of all beams arriving at the user equipment being less than a preset value;
Scheme 2: all beams being from a same transmission-reception point (TRP);
Scheme 3: all beams being from different transmission-reception points (TRPs), with distances between TRPs being less than a certain preset value;
Scheme 4: all beams being from a same RRH antenna panel;
Scheme 5: all beams being from different antenna panels at a same RRH site, wherein the different antenna panels must point towards a same direction;
Scheme 6: all beams being from different antenna panels at a same RRH site, wherein the different antenna panels may point towards different directions.

It can be seen in conjunction with the above detailed description of this specific implementation that, compared with the prior art, the beneficial technical effects of this scheme include but are not limited to: enabling the UE to obtain information on Active TCI state Switching configured by network-side entities through information in broadcast information or configuration information, such that the UE could perform uplink timing adjustment according to this information, which increases success probability of the Active TCI state Switching.

Additionally or alternatively, based on the first information transmitted by the network-side entity to the user equipment (UE), the UE may determine whether the network-side entity requires or allows the UE to enable or disable uplink timing adjustment, which may be optimized for high-speed scenarios, and may be achieved by adjusting the uplink timing advance (TA), for example, one shot uplink timing adjustment, and for another example, one shot large uplink timing adjustment, such that the UE can perform corresponding optimization and operations. The first information comprises at least one of the following:
Scheme 1: an indication bit transmitted by cell broadcast information (such as information contained in a broadcast SIB), which is used to indicate whether all the UEs in the cell are required or allowed to enable or disable uplink timing adjustment;
Scheme 2: an indication bit transmitted by cell broadcast information (such as information contained in a broadcast SIB), which is used to indicate whether in the case of a condition Y being met (such as information contained in the broadcast SIB), a specific UE in the cell enables or disables uplink timing advance (TA) adjustment, which may be optimized for high-speed scenarios. In one embodiment, a network-side entity may transmit an indication bit named highSpeedOneShotLargeULTimingAdjustmentFR2Flag to indicate whether the UE enables or disables uplink timing advance (TA) adjustment;
Scheme 3: an indication bit transmitted through configuration information for the user equipment (e.g., RRC signaling for the user equipment), which is used to indicate whether the UE is required or allowed to enable or disable uplink timing adjustment;
Scheme 4: an indication bit transmitted through configuration information for the user equipment (e.g., RRC signaling for the user equipment), which is used to indicate whether in the case of a condition Y being met, the UE is required or allowed to enable or disable uplink timing adjustment, which be optimized for high-speed scenarios, and may be achieved by adjusting uplink timing advance (TA), such as one shot large uplink timing adjustment.

The specific UE in the cell in the above scheme 2 comprises at least one of the following:
Scheme 1: User equipment with a specific transmission power class in the cell;
Scheme 2: User equipment with a specific user equipment type (UE Type) in the cell, wherein the user equipment type may be explicitly defined, or may be implicitly defined by the transmission power class of the user equipment. For example, a UE type corresponding to a power class of a UE is a UE placed on the roof of a high-speed train (High-Speed Train Roof-Mounted UE);
Scheme 3: User equipment in the cell that supports uplink timing adjustment;
Scheme 4: all UEs in the cell; and
A combination of the above schemes.

The above condition Y comprises at least one of the following:
Scheme 1: an absolute value of a downlink timing difference between a downlink timing (DL Timing) obtained by the UE based on a received specific downlink reference signal (in one embodiment, the specific downlink reference signal comprises a downlink reference signal corresponding to a target TCI state in an Active TCI state Switching instruction received by the UE. In a more specific embodiment, the above-mentioned downlink reference signal may be SSB and/or CSI-RS (Channel State Information-Reference Signal) and/or TRS (Tracking Reference signal). In a more specific embodiment, the above Active TCI state Switching instruction comprises at least one of the following: an Active TCI state Switching command corresponding to a physical channel (e.g., PDSCH and/or PDCCH) and/or a reference signal (e.g., CSI-RS)) and a current downlink timing of the UE being greater than a certain threshold;
Scheme 2: the UE needs to perform Active TCI state Switching corresponding to a certain physical channel (e.g., Physical Downlink Shared Channel (PDSCH) and/or Physical Downlink Control Channel (PDCCH)) and/or a reference signal (e.g., CSI-RS);
Scheme 3: the UE needs to perform Active TCI state Switching corresponding to a certain physical channel (e.g., PDSCH and/or PDCCH) and/or a reference signal (e.g., CSI-RS), and an absolute value of a downlink timing difference between a downlink timing obtained by the UE based on a downlink reference signal (e.g., SSB and/or CSI-RS and/or TRS (Timing Reference Signal)) corresponding to a received target TCI state and a current downlink timing of the UE is greater than a certain threshold;
Scheme 4: the UE needs to perform Active TCI state Switching corresponding to a certain physical channel (e.g., PDSCH and/or PDCCH) and/or a reference signal (e.g., CSI-RS), and the Active TCI state Switching meets a condition Z;
Scheme 5: the UE needs to perform Active TCI state Switching corresponding to a certain physical channel (e.g., PDSCH and/or PDCCH) and/or a reference signal (e.g., CSI-RS), and the Active TCI state Switching meets a condition Z, and an absolute value of a downlink timing difference between a downlink timing obtained by the UE based on a downlink reference signal (e.g., SSB and/or CSI-RS and/or TRS (Timing Reference Signal)) corresponding to a received target TCI state and a current downlink timing of the UE is greater than a certain threshold.

In schemes 4 and 5 of the above-mentioned condition Y, the condition Z met by the Active TCI state Switching comprises at least one of the following:
Scheme 1: the Active TCI state Switching is inter-RRH switching, that is, the source TCI state and the target TCI state are located at different RRH sites. This information may be determined by the UE according to first information transmitted by a network-side entity, or may be determined by the UE autonomously. In a more specific embodiment, the above-mentioned method used by the UE to perform autonomous determination is that: the UE determines whether the TCI state Switching is inter-RRH switching based on whether an absolute value of a downlink timing difference between a downlink timing obtained by the UE based on a downlink reference signal (e.g., SSB and/or CSI-RS and/or TRS (Timing Reference Signal)) corresponding to a received target TCI state and a current downlink timing of the UE is greater than a certain threshold (if the absolute value is greater than the above threshold, the TCI state Switching is inter-RRH switching).
Scheme 2: the Active TCI state switching is inter-SSB group switching, that is, the source TCI state and the target TCI state are located in different SSB groups. This information can be determined by the UE according to first information transmitted by a network-side entity, or may be determined by the UE autonomously. In a more specific embodiment, the above-mentioned method used by the UE to perform autonomous determination is that: the UE determines whether the TCI state Switching is inter-SSB group switching based on whether an absolute value of a downlink timing difference between a downlink timing obtained by the UE based on a SSB corresponding to a received target TCI state and a current downlink timing of the UE is greater than a certain threshold (if the absolute value is greater than the above threshold, the TCI state Switching is inter-SSB group switching).
Scheme 3: the Active TCI state Switching is cross-TCI state group switching, that is, the source TCI state and the target TCI state are located in different TCI state groups. This information may be determined by the UE according to first information transmitted by a network-side entity, or may be determined by the UE autonomously. In a more specific embodiment, the above-mentioned method used by the UE to perform autonomous determination is that: the UE determines whether the TCI state Switching is cross-TCI state group switching based on whether an absolute value of a downlink timing difference between a downlink timing obtained by the UE based on a downlink reference signal (e.g., SSB and/or CSI-RS and/or TRS) corresponding to a received target TCI state and a current downlink timing of the UE is greater than a certain threshold (if the absolute value is greater than the above threshold, the TCI state Switching is cross-TCI state group switching).

The threshold value of the certain threshold in Scheme 1, Scheme 3 and Scheme 5 of the above condition Y may be determined by the UE autonomously, or may be a predefined value, or may be indicated by the network through signaling. The threshold value of the certain threshold in Scheme 1, Scheme 3 and Scheme 5 of the above condition Y may be properly adjusted according to the subcarrier spacing (SCS) of the SSB or other reference signals. A typical value of the threshold value may be for example, 4.5*64*T_{c}, wherein the value of T_{c} may be predefined.

It can be seen in conjunction with the above detailed description of this specific implementation that, compared with the prior art, the beneficial technical effects of this scheme include but are not limited to: enabling the UE to obtain information on Active TCI state switching configured by network-side entities and other information through information in broadcast information or configuration information, such that the UE can adjust uplink timing according to these information, thereby increasing success probability of the Active TCI state Switching.

According to another aspect of the present disclosure, the present disclosure discloses a communication method performed by a user equipment (UE) comprising: receiving, by the user equipment, from network-side a request for requesting the user equipment to report its capabilities (and/or operating states), or reporting, autonomously by the user equipment its capabilities (and/or operating states), the capabilities (and/or operating states) being transmitted through second information on UE capabilities, which capabilities may comprise at least one of the following:
Scheme 1: a transmission power class of the user equipment;
Scheme 2: a UE type corresponding to the radio frequency power class of the user equipment. For example, the UE type corresponding to the power class of the UE is a High-Speed Train Roof-Mounted UE;
Scheme 3: capabilities in a high-speed railway scenario corresponding to the UE type corresponding to the Radio frequency power class of the user equipment.
Scheme 4: the capability whether the user equipment supports uplink timing adjustment, specifically, the adjustment may be optimized for high-speed scenarios, and may be achieved by adjusting the uplink timing advance (TA).

The operating states may comprise at least one of the following: a radio frequency operating mode, a mobility management operating mode, and a high-speed mobility state of a terminal; and the terminal reports its capabilities (and/or operating states) based on the actual situation, according to the received request for reporting capabilities of the terminal required from the network-side.

It can be seen in conjunction with the above detailed description of this specific implementation that, compared with the prior art, the beneficial technical effects of this solution include, but are not limited to: enabling network-side entities to obtain capabilities information of the user equipment (UE) by transmitting second information through the communication method performed by the UE, such that the network-side entities can perform corresponding operations based on the capability information of the UE, thereby ensuring that the UE adopts an appropriate uplink timing adjustment scheme, and thus increase success probability of the Active TCI state Switching.

The present disclosure discloses a communication method performed by a network-side entity comprising: transmitting, by the network-side entity, third information determined based on second information to a UE, through which the UE can determine characteristics of Active TCI state Switching configured by the network-side entity, such as whether it is inter-RRH switching, such that the UE can perform corresponding optimization and operations. The third information may comprise at least one of the following:
Scheme 1: a MAC CE based on the second information for indicating TCI state-related information corresponding to a UE-specific PDCCH (in a specific embodiment, the MAC CE is a MAC CE used for indication of TCI state for UE-specific PDCCH for FR2 High-Speed Train), which indicates whether a beam corresponding to a target TCI state and a beam corresponding to a TCI state of a currently used PDCCH meet a condition X.
Scheme 2: information indicating a relationship between SSBs (Synchronization Signal blocks) and/or correspondence between SSBs and RRHs in configuration information for the user equipment (e.g., RRC signaling for the user equipment) based on the second information:
The relationship between SSBs: for example, one or more SSB indexes being grouped into one SSB group, all SSB indexes being grouped into multiple SSB groups, beams corresponding to SSB indexes in a same group meeting a condition X, and beams corresponding to SSB indexes in different groups not meeting the condition X;
The correspondence between SSBs and RRHs: for example, RRH number(s) corresponding to one or more SSB indexes, so as to determine SSB index information corresponding to each RRH.
Scheme 3: information indicating a relationship between TCI states and/or correspondence between TCI states and RRHs in configuration information for the user equipment (e.g., RRC signaling for the user equipment) based on the second information:
The relationship between TCI states: for example, one or more TCI states being grouped into one TCI state group, all TCI states being grouped into multiple TCI state groups, beams corresponding to TCI states in a same group meeting condition X, and beams corresponding to TCI states in different groups not meeting the condition X (as indicated above);
The correspondence between TCI states and RRHs: for example, RRH index (or indexes) corresponding to one or more TCI states, so as to determine TCI state information corresponding to each RRH.
Scheme 4: a joint MAC CE based on the second information, which jointly indicates a MAC CE of a TCI state corresponding to a UE-specific PDCCH (indication of TCI state for UE-specific PDCCH) and a MAC CE of a UE Timing Advance command, which is used to simultaneously indicate the MAC CE of the TCI state corresponding to the UE-specific PDCCH and the UE Timing Advance command, wherein UE Timing Advance command may be an absolute timing advance or a relative timing advance.

It can be seen in conjunction with the above detailed description of this specific embodiment that, compared with the prior art, the beneficial technical effects of this scheme include but are not limited to: enabling the UE to obtain information of Active TCI state Switching configured by network-side entities through the third information, such that the UE can adjust uplink timing according to the information, which increases success probability of Active TCI state Switching.

Additionally or alternatively, the network-side entity transmits third information determined based on the second information to the UE, and through the third information, the network-side entity requires or allows the UE to enable or disable uplink timing adjustment, such as one shot large uplink timing adjustment, such that the UE can perform corresponding optimization and operations. The third information may comprise at least one of the following:
Scheme 1: an indication bit transmitted through configuration information for the user equipment (e.g., RRC signaling for the user equipment) based on the second information transmitted by the UE, which is used to indicate whether the UE is required or allowed to enable or disable uplink timing adjustment;
Scheme 2: an indication bit transmitted through configuration information for the user equipment (e.g., RRC signaling for the user equipment) based on the second information transmitted by the UE, which is used to indicate whether in the case of a condition Y being met, the UE is required or allowed to enable or disable uplink timing adjustment, such as one shot large uplink timing adjustment.

It can be seen in conjunction with the above detailed description of this specific implementation that, compared with the prior art, the beneficial technical effects of this scheme include, but are not limited to: through the third information, a network-side entity is enabled to require or allow a UE to enable or disable an uplink timing advance (TA) adjustment scheme optimized for high-speed scenarios, such that the network controls the UE to adopt an appropriate uplink timing adjustment scheme, thereby increasing success probability of Active TCI state Switching.

According to another aspect of the present disclosure, the present disclosure discloses uplink timing adjustment performed by a UE comprising: calculating a value of uplink Timing Advance (TA), by the UE, based on a received instruction and/or information on uplink timing advance (TA) transmitted by a network-side entity in combination with other information, for uplink signal transmission, and proceeding to adjust a scheme of uplink timing advance, the scheme may comprise at least one of the following:

Step 1: receiving, by the UE, uplink timing advance (TA) related information from the network-side entity, the uplink TA related information comprising at least one of the following:
information of a value of timing advance offset (N_{TA offset})
timing advance command (which comprises information on N_{TA}, wherein the physical meaning of N_{TA} is a timing advance amount that a network-side entity requires the UE to use when transmitting an uplink signal, with T_{c} as a quantized unit)
Other timing advance related information.

Step 2: calculating a value of the uplink timing advance (TA), by the UE, based on the received information on the uplink timing advance (TA) and downlink timing related information, wherein the downlink timing related information comprises but is not limited to:
T₁, which is current downlink timing of the UE
T₂, which is downlink timing (DL Timing) obtained by the UE based on a received specific downlink reference signal (Timing Reference Signal).

Then at an appropriate time point Q, the UE transmits an uplink signal to the network-side entity with the calculated value of the uplink timing advance (TA), wherein the uplink signal comprises at least one of the following: an uplink control channel (for example, PUCCH (Physical Uplink Control Channel)), uplink data channel (for example, PUSCH (Physical Uplink Shared Channel)) and uplink reference signal.

In one embodiment, Timing Advance (TA) may be calculated by following formula:

TA=T₂−(N_{TA}+N_{TA offset})*T_{c}+C*(T₁−T₂),
wherein, C may be a constant, for example, which may be 2, and N_{TA offset} is timing advance offset, N_{TA} is a value determined based on the timing advance command, and N_{TA offset} and N_{TA} are determined based on the received uplink timing advance (TA) related information.

In one embodiment, an absolute value of a downlink timing difference between the downlink timing T₂ and the downlink timing T₁ is greater than a certain threshold.

The above T₂ is downlink timing (DL Timing) obtained by the UE based on the received specific downlink reference signal (Timing Reference Signal). In one embodiment, the specific downlink reference signal comprises a downlink reference signal corresponding to a target TCI state in an Active TCI state Switching instruction received by the UE. In a more specific embodiment, the above downlink reference signal may be SSB and/or CSI-RS and/or TRS. In a more specific embodiment, the above Active TCI state Switching command comprises at least one of the following: an Active TCI state Switching command corresponding to a physical channel (e.g., PDSCH and/or PDCCH) and/or a reference signal (e.g., CSI-RS).

In one embodiment, the appropriate time point Q in the above step 2 may be transmission timing of a first uplink transmission signal subsequent to a first reference signal (e.g., TRS and/or SSB) received according to the Active TCI state Switching by the UE. In a more specific embodiment, the UE may be allowed to not be scheduled for uplink and/or downlink channel transmission by the network-side entity before the above time point Q.

In various embodiments, the target TCI state and the current TCI state of the UE are in different TCI state groups; or the SSBs corresponding to the target TCI state and the SSBs corresponding to the current TCI state of the UE are in different SSBs group; or the SSB-related RRHs corresponding to the target TCI state are different from the SSB-related RRHs corresponding to the current TCI state of the UE; or it is determined that the switching is cross-RRH switching or inter-RRH switching based on the target TCI state and the current TCI state of the UE.

The TCI state group information or the SSB group information or the SSB-related RRH information or the cross-RRH switching or the inter-RRH switching are determined by the UE from the first information or the third information received from the network-side entity, wherein the third information is determined by the network-side entity based on the second information it receives from the UE. Specifically, the implementations of the first information and the third information are as described above.

For example, the first information may comprise at least one of the following: information on a relationship between SSBs and/or correspondence between SSBs and RRHs, wherein the first information is indicated via cell broadcast information or indicated via UE configuration information; and a relationship between TCI states and/or correspondence between the TCI states and RRHs, wherein the first information is indicated via UE configuration information.

For another example, the third information may comprise at least one of the following: a MAC CE for indicating TCI state related information, the MAC CE indicating a TCI state corresponding to a UE-specific PDCCH and whether a beam corresponding to the TCI state and a beam corresponding to a TCI state of a currently used PDCCH meet a first specific condition; information in configuration information for the UE indicating a relationship between SSBs, and/or correspondence between SSBs and RRHs; information in configuration information for the UE indicating a relationship between TCI states and/or correspondence between TCI states and RRHs; and a MAC CE indicating a TCI state corresponding to a UE-specific PDCCH and the UE timing advance command.

As described above, in various embodiments, through the first information and/or the third information, a network-side entity may indicate to the UE whether the UE enables or disables one shot uplink timing adjustment or whether the UE is allowed to enable or disable one shot uplink timing adjustment. The first information and/or the third information may be transmitted through cell broadcast information or transmitted as configuration information for the UE. More specifically, the first information may comprise at least one of the following: information transmitted through cell broadcast information, which is used to indicate whether all the UEs in the cell enable or disable one shot uplink timing adjustment or whether the UEs are allowed to enable or disable one shot uplink timing adjustment; information transmitted through cell broadcast information, which is used to indicate whether a specific UE in a cell enables or disables one shot uplink timing adjustment or whether the specific UE in the cell is allowed to enable or disable one shot uplink timing adjustment; and information transmitted in configuration information for the UE, which is used to indicated that the UE enables or disables one shot uplink timing adjustment or whether the UE is allowed to enable or disable one shot uplink timing adjustment.

The specific UE comprises at least one of the following: a UE with a specific radio frequency power class; a UE with a specific user equipment type; and a UE supporting uplink timing adjustment.

In a further embodiment, the second information comprises at least one of the following: user equipment capabilities; and user equipment operating states.

In a further embodiment, the user equipment capabilities comprise at least one of the following: a radio frequency power class of a user equipment; a UE type corresponding to the radio frequency power class of the user equipment; capabilities in a high-speed railway scenario corresponding to the UE type corresponding to the radio frequency power class of the user equipment; and a capability as to whether the user equipment supports uplink timing adjustment.

In a further embodiment, the operating states comprise at least one of the following: a radio frequency operating mode of the UE; a mobility management operating mode of the UE; and a high-speed mobility state of the UE.

For another example, the third information comprises at least one of the following: a MAC CE for indicating TCI state related information, the MAC CE indicating a TCI state corresponding to a UE-specific PDCCH and whether a beam corresponding to the TCI state and a beam corresponding to a TCI state of a currently used PDCCH meet a first specific condition; information in configuration information for the UE indicating a relationship between SSBs, and/or correspondence between SSBs and RRHs; information in configuration information for the UE indicating a relationship between TCI states and/or correspondence between TCI states and RRHs; and a MAC CE indicating a TCI state corresponding to a UE-specific PDCCH and UE timing advance command.

In a further embodiment, the third information may be used for the UE to enable or disable one shot uplink timing adjustment or whether the UE is allowed to enable or disable one shot uplink timing adjustment, which comprises: information transmitted in configuration information for the UE, which is used to indicate whether the UE enables or disables one shot uplink timing adjustment or whether the UE is allowed to enable or disable one shot uplink timing adjustment.

In a further embodiment, the first specific condition is at least one of the following: a propagation delay difference of all beams arriving at the UE being less than a preset value; all beams being from a same transmission-reception point TRP; all beams being from different TRPs with a distance between the TRPs being less than a preset value; all beams being from a same RRH antenna panel; all beams being from different antenna panels at a same RRH site, wherein the different antenna panels must point towards a same direction; and all beams being from different antenna panels at a same RRH site, wherein the different antenna panels may point towards different directions.

In a more specific embodiment, when a network-side entity instructs a UE to enable uplink timing adjustment, the UE performs the above calculation, otherwise the TA calculation is performed according to the prior art. In another embodiment, through the first information and/or the third information, the UE can determine whether TCI state switching in Active TCI state Switching instruction instructed by the network-side entity to be received by the UE meets a condition Y. In a more specific embodiment, when the condition Y is met, the UE performs the above calculation, otherwise the TA calculation is performed according to the prior art. In another embodiment, through the first information and/or the third information, the UE can determine whether TCI state switching in Active TCI state Switching instruction instructed by the network-side entity to be received by the UE is inter-RRH switching. In a more specific embodiment, when the TCI state switching in Active TCI state Switching instruction instructed by the network-side entity to be received by the UE is inter-RRH switching, the UE performs the above calculation, otherwise the TA calculation is performed according to the prior art.

The condition Y includes at least one of the following:
Scheme 1: an absolute value of a downlink timing difference between a downlink timing (DL Timing) obtained by the UE based on a received specific downlink reference signal (in one embodiment, the specific downlink reference signal comprises a downlink reference signal corresponding to a target TCI state in an Active TCI state Switching instruction received by the UE. In a more specific embodiment, the above-mentioned downlink reference signal may be SSB and/or CSI-RS and/or TRS. In a more specific embodiment, the above Active TCI state Switching instruction comprises at least one of the following: an Active TCI state Switching command corresponding to a physical channel (e.g., PDSCH and/or PDCCH) and/or a reference signal (e.g., CSI-RS)) and a current downlink timing of the UE being greater than a certain threshold;
Scheme 2: the UE needs to perform Active TCI state Switching corresponding to a certain physical channel (e.g., Physical Downlink Shared Channel (PDSCH) and/or Physical Downlink Control Channel (PDCCH)) and/or a reference signal (e.g., CSI-RS);
Scheme 3: the UE needs to perform Active TCI state Switching corresponding to a certain physical channel (e.g., PDSCH and/or PDCCH) and/or a reference signal (e.g., CSI-RS), and an absolute value of a downlink timing difference between a downlink timing obtained by the UE based on a downlink reference signal (e.g., SSB and/or CSI-RS and/or TRS (Timing Reference Signal)) corresponding to a received target TCI state and a current downlink timing of the UE is greater than a certain threshold;
Scheme 4: the UE needs to perform Active TCI state Switching corresponding to a certain physical channel (e.g., PDSCH and/or PDCCH) and/or a reference signal (e.g., CSI-RS), and the Active TCI state Switching meets a condition Z;
Scheme 5: the UE needs to perform Active TCI state Switching corresponding to a certain physical channel (e.g., PDSCH and/or PDCCH) and/or a reference signal (e.g., CSI-RS), and the Active TCI state Switching meets a condition Z, and an absolute value of a downlink timing difference between a downlink timing obtained by the UE based on a downlink reference signal (e.g., SSB and/or CSI-RS and/or TRS (Timing Reference Signal)) corresponding to a received target TCI state and a current downlink timing of the UE is greater than a certain threshold.

In schemes 4 and 5 of the above-mentioned determinations, the condition Z met by the Active TCI state Switching comprises at least one of the following:
Scheme 1: the Active TCI state Switching is inter-RRH switching, that is, the source TCI state and the target TCI state are located at different RRH sites. This information may be determined by the UE according to first information transmitted by a network-side entity, or may be determined by the UE autonomously. In a more specific embodiment, the above-mentioned method used by the UE to perform autonomous determination is that: the UE determines whether the TCI state Switching is inter-RRH switching based on whether an absolute value of a downlink timing difference between a downlink timing obtained by the UE based on a downlink reference signal (e.g., SSB and/or CSI-RS and/or TRS (Timing Reference Signal)) corresponding to a received target TCI state and a current downlink timing of the UE is greater than a certain threshold (if the absolute value is greater than the above threshold, the TCI state Switching is inter-RRH switching).
Scheme 2: the Active TCI state switching is inter-SSB group switching, that is, the source TCI state and the target TCI state are located in different SSB groups. This information can be determined by the UE according to first information transmitted by a network-side entity, or may be determined by the UE autonomously. In a more specific embodiment, the above-mentioned method used by the UE to perform autonomous determination is that: it is determined whether the TCI state Switching is inter-SSB group switching based on whether an absolute value of a downlink timing difference between a downlink timing obtained by the UE based on a SSB corresponding to a received target TCI state and a current downlink timing of the UE is greater than a certain threshold (if the absolute value is greater than the above threshold, the TCI state Switching is inter-SSB group switching).
Scheme 3: the Active TCI state Switching is cross-TCI state group switching, that is, the source TCI state and the target TCI state are located in different TCI state groups. This information may be determined by the UE according to first information transmitted by a network-side entity, or may be determined by the UE autonomously. In a more specific embodiment, the above-mentioned method used by the UE to perform autonomous determination is that: the UE determines whether the TCI state Switching is cross-TCI state group switching based on whether an absolute value of a downlink timing difference between a downlink timing obtained by the UE based on a downlink reference signal (e.g., SSB and/or CSI-RS and/or TRS) corresponding to a received target TCI state and a current downlink timing of the UE is greater than a certain threshold (if the absolute value is greater than the above threshold, the TCI state Switching is cross-TCI state group switching).

The threshold value of the certain threshold in Scheme 1, Scheme 3 and Scheme 5 of the above determination may be determined by the UE autonomously, or may be a predefined value, or may be indicated by the network through signaling. The threshold value of the certain threshold in Scheme 1, Scheme 3 and Scheme 5 of the above condition Y may be properly adjusted according to the subcarrier spacing (SCS) of the SSB or other reference signals. A typical value of the threshold value may be for example, 4.5*64*T_{c}, wherein the value of T_{c} may be predefined.

In one embodiment, the determination as to whether the Active TCI state Switching meets the condition Z may be determined based on the first information and/or the third information.

Step 3: under the condition that the TA adjustment rate actually used by the UE is less than a certain threshold value, the UE performs an operation of autonomously adjusting the uplink timing, such that the TA value used by the UE gradually approaches the TA value indicated by the network-side entity. (The threshold value is defined as a magnitude of the TA value adjusted within a unit time, such as Tq per second). In a more specific embodiment, the UE performs uplink timing adjustment such that the TA value used by the UE gradually approaches (N_{TA}+N_{TA offset})*T_{c}, wherein N_{TA offset}, and N_{TA} are determined based on the received uplink timing advance (TA) related information, and wherein T_{c} is a constant.

In an embodiment, the threshold value may be a preset value, or may be configured by a network-side entity through signaling.

In another embodiment, the operation of autonomously adjusting uplink timing by the UE is predefined.

Compared with the prior art, this specific embodiment at least has the following beneficial technical effects:

First, through this scheme, the network-side entity can receive the uplink signal transmission of the UE without updating the TA value of the UE, thereby avoiding signaling overhead and resource waste caused when updating the UE TA;

Second, through this scheme, the following problems are avoided: in the existing scheme (for example, random access-based scheme), the timing occasion that the network-side entity transmits the PDCCH order to trigger the random access of the UE is selected too early, so that during inter-RRH Active TCI state, the RRHs where the target TCI state is located cannot receive the random access signal, which in turn causes the network-side entity to fail to obtain the UE uplink timing information.

Third, through this scheme, the following problems are avoided: in the existing scheme (for example, random access-based scheme), the timing occasion that the network-side entity transmits the PDCCH order to trigger the random access of the UE is selected too late, so that the process of inter-RRH Active TCI state Switching completes too late, which in turn causes failure of Active TCI state Switching process.

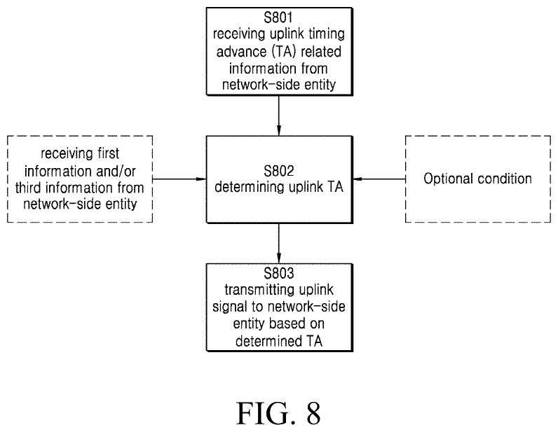

FIG. 8 illustrates a method performed by a UE according to an embodiment of the present disclosure. As an example, a UE comprises: a transceiver configured to transmit and receive a signal; and a processor configured to perform the methods described herein.

In step S801, the UE receives uplink timing advance (TA) related information from a network-side entity. In step S802, the UE determines uplink timing advance (TA) based on the received uplink timing advance (TA) related information and downlink timing related information, wherein the downlink timing related information comprises a current downlink timing T₁ of the UE and a downlink timing T₂ obtained by the UE based on a received specific downlink reference signal. In step S803, an uplink signal is transmitted to the network-side entity based on the determined TA. In a specific embodiment, the TA is determined by the following: TA=T₂−(N_{TA}+N_{TA offset})*T_{c}+C*(T₁−T₂), wherein C and T_{c} are constants, N_{TA offset} is a timing advance offset, N_{TA} is a value determined based on a timing advance command, and wherein, N_{TA offset} and N_{TA} are determined based on the received uplink timing advance (TA) related information.

In one embodiment, the specific downlink reference signal comprises: a SSB and/or CSI-RS and/or TRS corresponding to a target TCI state received by the UE. In a more specific embodiment, the specific downlink reference signal comprises: a SSB and/or CSI-RS and/or TRS corresponding to a target TCI state in an Active TCI state Switching instruction received by the UE, and wherein the Active TCI state Switching instruction comprises an Active TCI state Switching instruction corresponding to a physical channel and/or reference signal.

In some embodiments, an absolute value of a downlink timing difference between the downlink timing T₂ and the downlink timing T₁ is greater than a certain threshold.

In some embodiments, the target TCI state and a current TCI state of the UE are in different TCI state groups; or a SSB corresponding to the target TCI state and a SSB corresponding to the current TCI state of the UE are in different SSB groups; or a SSB-related RRH corresponding to the target TCI state is different from a SSB-related RRH corresponding to the current TCI state of the UE.

Optionally, the method further comprises: receiving, by the UE, first information and/or third information from the network-side entity; wherein the third information is determined by the network-side entity based on the second information it receives from the UE, and wherein the first information and the third information may be implemented as various schemes as described above.

In a further embodiment, the method further comprises: the TCI state group information or the SSB group information or the SSB-related RRH information is determined by the first information or the third information.

In a further embodiment, the method further comprises: performing, by the UE, an uplink timing adjustment, such that a TA value used by the UE gradually approaches (N_{TA}+N_{TA offset})*T_{c}, wherein N_{TA offset} and N_{TA} are determined based on the received uplink timing advance (TA) related information, and wherein T_{c} is a constant.

In a further embodiment, the first information comprises at least one of the following: information on a relationship between SSBs and/or correspondence between SSBs and RRHs, wherein the first information is indicated via cell broadcast information or via UE configuration information; and a relationship between TCI states and/or correspondence between TCI states and RRHs, wherein the first information is indicated via the UE configuration information.

In a further embodiment, the first information is used to indicate whether a UE enables or disables one shot uplink timing adjustment or whether the UE is allowed to enable or disable one shot uplink timing adjustment, which comprises at least one of the following: information transmitted through cell broadcast information, which is used to indicate whether all the UEs in the cell enable or disable one shot uplink timing adjustment or whether the UEs are allowed to enable or disable one shot uplink timing adjustment; information transmitted through cell broadcast information, which is used to indicate whether a specific UE in a cell enables or disables one shot uplink timing adjustment or whether the specific UE in the cell is allowed to enable or disable one shot uplink timing adjustment; and information transmitted in configuration information for the UE, which is used to indicated that the UE enables or disables one shot uplink timing adjustment or whether the UE is allowed to enable or disable one shot uplink timing adjustment.

In a further embodiment, the specific UE comprises at least one of the following: a UE with a specific radio frequency power class; a UE with a specific user equipment type; and a UE supporting uplink timing adjustment.

In a further embodiment, the second information comprises at least one of the following: user equipment capabilities; and user equipment operating states.

In a further embodiment, the user equipment capabilities comprise at least one of the following: a radio frequency power class of a user equipment; a UE type corresponding to the radio frequency power class of the user equipment; capabilities in a high-speed railway scenario corresponding to the UE type corresponding to the radio frequency power class of the user equipment; and a capability as to whether the user equipment supports uplink timing adjustment.

In a further embodiment, the operating states comprise at least one of the following: a radio frequency operating mode of the UE; a mobility management operating mode of the UE; and a high-speed mobility state of the UE.

In a further embodiment, the third information comprises at least one of the following: a MAC CE for indicating TCI state related information, the MAC CE indicating a TCI state corresponding to a UE-specific PDCCH and whether a beam corresponding to the TCI state and a beam corresponding to a TCI state of a currently used PDCCH meet a first specific condition; information in configuration information for the UE indicating a relationship between SSBs, and/or correspondence between

SSBs and RRHs; information in configuration information for the UE indicating a relationship between TCI states and/or correspondence between TCI states and RRHs; and a MAC CE indicating a TCI state corresponding to a UE-specific PDCCH and UE timing advance command.

In a further embodiment, the third information is used for indicating that the UE enables or disables one shot uplink timing adjustment or whether the UE is allowed to enable or disable one shot uplink timing adjustment, which comprises: information transmitted in configuration information for the UE, which is used to indicate whether the UE enables or disables one shot uplink timing adjustment or whether the UE is allowed to enable or disable one shot uplink timing adjustment.

In a further embodiment, the first specific condition is at least one of the following: a propagation delay difference of all beams arriving at the UE being less than a preset value; all beams being from a same transmission-reception point TRP; all beams being from different TRPs with a distance between the TRPs being less than a preset value; all beams being from a same RRH antenna panel; all beams being from different antenna panels at a same RRH site, wherein the different antenna panels must point towards a same direction; and all beams being from different antenna panels at a same RRH site, wherein the different antenna panels may point towards different directions.

In one embodiment, the TA is calculated by:

$$TA = {T}_{2} - ( {N}_{TA} + {N}_{TA offset} ) * {T}_{c} + C * ( {T}_{1} - {T}_{2} ) ,$$

wherein, C is a constant, N_{TA offset} is a timing advance offset, and N_{TA} is a value determined based on the timing advance command.

Those skilled in the art will understand that the above-described illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily appreciated that the various aspects of the present disclosure, as generally described herein and illustrated in the accompanying drawings, may be arranged, substituted, combined, separated, and designed in various different configurations, all of which are herein was envisaged.

Those of skill in the art will understand that the various illustrative logical blocks, modules, circuits, and steps described herein can be implemented as hardware, software, or combinations of both. To clearly illustrate this interchangeability of hardware and software, various illustrative components, blocks, modules, circuits, and steps have been described above generally in terms of their function sets. Whether such a feature set is implemented as hardware or software depends on the specific application and design constraints imposed on the overall system. Those skilled in the art may implement the described function sets in varying ways for each particular application, but such design decisions should not be interpreted as causing a departure from the scope of this disclosure.

The various illustrative logical blocks, modules, and circuits described in this disclosure may be implemented or performed in general-purpose processors, digital signal processors (DSPs), application specific integrated circuits (ASICs), field programmable gate arrays (FPGAs) or other programmable logic devices, discrete gates or transistor logics, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, multiple microprocessors, one or more microprocessors cooperating with a DSP core, or any other such configuration.

The steps of a method or algorithm described herein may be embodied directly in hardware, in a software module executed by a processor, or in a combination of the two. A software module may reside in RAM memory, flash memory, ROM memory, EPROM memory, EEPROM memory, registers, hard disk, removable disk, or any other form of storage medium known in the art. An exemplary storage medium is coupled to the processor such the processor can read information from, and write information to, the storage medium. In the alternative, the storage medium may be integrated into the processor. The processor and storage medium may reside in the ASIC. The ASIC may reside in the user terminal. In the alternative, the processor and storage medium may reside in the user terminal as discrete components.

In one or more exemplary designs, the functions may be implemented in hardware, software, firmware, or any combination thereof. If implemented in software, the functions may be stored on or transmitted over as one or more instructions or code in a computer-readable medium. Computer-readable media comprises both computer storage media and communication media including any medium that facilitates transfer of a computer program from one place to another. A storage medium can be any available medium that can be accessed by a general purpose or special purpose computer.

The above description is only exemplary embodiments of the present disclosure and is not intended to limit the scope of the present disclosure, which is defined by the appended claims.

1. A method performed by a user equipment (UE) in a wireless communication system, the method comprising:
receiving a timing advance command from a network-side equipment;
performing transmission configuration indicator (TCI) state switching from a source TCI state to a target TCI state;
identifying uplink timing based on the received timing advance command and downlink timing related information, wherein the downlink timing related information comprises a downlink timing T₁ associated with the source TCI state and a downlink timing T₂ associated with the target TCI state; and
transmitting an uplink signal to the network-side equipment based on the identified uplink timing.

2. The method of claim 1, wherein the downlink timing T₂ is obtained by the UE based on a downlink reference signal comprising at least one of a synchronization signal block (SSB), channel state information reference signal (CSI-RS), or tracking reference signal (TRS), wherein the downlink reference signal corresponds to the target TCI state.

3. The method of claim 1, wherein an absolute value of a downlink timing difference between the downlink timing T₂ and the downlink timing T₁ is greater than a certain threshold.

4. The method of claim 1, wherein the uplink timing is identified based on T₂-(N_{TA}+N_{TA offset})*T_{c}+C*(T₁−T₂), where C and T_{c} are constants, N_{TA offset} is a timing advance offset, and N_{TA} is a value identified based on the received timing advance command.

5. The method of claim 4, wherein C is equal to 2.

6. The method of claim 1, further comprising:
performing an uplink timing adjustment, such that a timing advance (TA) value used by the UE gradually approaches (N_{TA}+N_{TA offset})*T_{c}, wherein N_{TA offset} is a timing advance offset, N_{TA} is identified based on the received timing advance command, and T_{c} is a constant.

7. The method of claim 1, further comprising:
receiving first information from the network-side equipment, wherein the first information indicates whether one shot uplink timing adjustment is enabled, and the first information is received through cell broadcast information or configuration information for the UE.

8. The method of claim 1, wherein the UE comprises at least one of:
a UE with a specific radio frequency power class;
a UE with a specific user equipment type; and
a UE supporting uplink timing adjustment.

9. The method of claim 8, wherein the UE with the specific user equipment type comprises a high-speed train roof-mounted UE.

10. The method of claim 1, further comprising:
transmitting second information to the network-side equipment, wherein the second information comprises at least one of:
user equipment capabilities; and
user equipment operating states.

11. The method of claim 10, wherein the user equipment capabilities comprise at least one of the following:
a radio frequency power class of the UE;
a UE type corresponding to the radio frequency power class of the UE;
capabilities in a high-speed railway scenario corresponding to the UE type corresponding to the radio frequency power class of the user equipment; and
a capability as to whether the UE supports uplink timing adjustment.

12. The method of claim 1, further comprising:
receiving third information from the network-side equipment, wherein the third information comprises at least one of the following:
a medium access control control element (MAC CE) for indicating TCI state related information, the MAC CE indicating a TCI state corresponding to a UE-specific PDCCH and whether a beam corresponding to the TCI state and a beam corresponding to a TCI state of a currently used PDCCH meet a first specific condition;
information in configuration information for the UE indicating a relationship between SSBs, or correspondence between SSBs and RRHs;
information in configuration information for the UE indicating a relationship between TCI states or correspondence between TCI states and RRHs; and
a MAC CE indicating a TCI state corresponding to a UE-specific PDCCH and UE timing advance command.

13. A user equipment (UE) in a wireless communication system, the UE comprising:
a transceiver; and
a processor coupled to the transceiver and configured to:
control the transceiver to receive a timing advance command from a network-side equipment;
perform transmission configuration indicator (TCI) state switching from a source TCI state to a target TCI state;
identify an uplink timing based on the received timing advance command and downlink timing related information, wherein the downlink timing related information comprises a downlink timing T₁ associated with the source TCI state and a downlink timing T₂ associated with the target TCI state; and
control the transceiver to transmit an uplink signal to the network-side equipment based on the identified uplink timing.

14. A method performed by a network-side equipment in a wireless communication system, the method comprising:
transmitting a timing advance command to a user equipment (UE);
configuring transmission configuration indicator (TCI) state switching from a source TCI state to a target TCI state; and
receiving an uplink signal from the UE, wherein the uplink signal is received based on an uplink timing associated with the transmitted timing advance command and downlink timing related information, wherein the downlink timing related information comprises a downlink timing T₁ associated with the source TCI state and a downlink timing T₂ associated with the target TCI state.

15. A network-side equipment in a wireless communication system, the network-side equipment comprising:
a transceiver; and
a processor coupled to the transceiver and configured to control the transceiver to:
transmit a timing advance command to a user equipment (UE);
configure transmission configuration indicator (TCI) state switching from a source TCI state to a target TCI state; and
receive an uplink signal from the UE, wherein the uplink signal is received based on an uplink timing associated with the transmitted timing advance command and downlink timing related information, wherein the downlink timing related information comprises a downlink timing T₁ associated with the source TCI state and a downlink timing T₂ associated with the target TCI state.
